(19) United States
(12) Patent Application Publication
(10) Pub. No.: US 2026/0142081 A1
(43) Pub. Date: May 21, 2026

(54) MULTILAYER ELECTRONIC COMPONENT

(71) Applicant: SAMSUNG ELECTRO-MECHANICS CO., LTD., Suwon-si (KR)

(72) Inventors: Seong Min PARK, Suwon-si (KR); Seung Hun KANG, Suwon-si (KR); Jae Hoon JI, Suwon-si (KR); Hyun Woong NA, Suwon-si (KR); Kyung Ryul LEE, Suwon-si (KR); Hong Seok KIM, Suwon-si (KR)

(73) Assignee: SAMSUNG ELECTRO-MECHANICS CO., LTD., Suwon-si (KR)

(21) Appl. No.: 19/249,181

(22) Filed: Jun. 25, 2025

(30) Foreign Application Priority Data
Nov. 20, 2024 (KR) 10-2024-0165946

(51) Int. Cl. H01G 4/008; H01G 4/12; H01G 4/232; H01G 4/248; H01G 4/30

(52) U.S. Cl. CPC H01G 4/008; H01G 4/1209; H01G 4/232; H01G 4/248; H01G 4/30

(57) ABSTRACT

A multilayer electronic component includes a body including a dielectric layer and an internal electrode alternately disposed with the dielectric layer; and an external electrode disposed on the body, wherein the internal electrode includes at least one selected from the group consisting of a MAX material and a Silicide material, and an auxiliary layer may be disposed at an interface between the internal electrode and the dielectric layer.

### CROSS-REFERENCE TO RELATED APPLICATION(S)

This application claims benefit of priority to Korean Patent Application No. 10-2024-0165946 filed on Nov. 20, 2024 in the Korean Intellectual Properties Office, the disclosure of which is incorporated herein by reference in its entirety.

### BACKGROUND

### 1. Field

The present disclosure relates to a multilayer electronic component.

### 2. Description of Related Art

A multilayer ceramic capacitor (MLCC), one of multilayer electronic components, is a chip-type condenser mounted on printed circuit boards of various electronic products such as an image display device, for example, a liquid crystal display (LCD), a plasma display panel (PDP), or the like, a computer, a smartphone, a mobile phone, and a circuit such as an on board charger (OBC) DC-DC converter of an electric vehicle, to serve to charge or discharge electricity therein or therefrom.

To form an internal electrode of the multilayer ceramic capacitor, a method in which a conductive paste for internal electrodes and a dielectric ceramic sheet are stacked, pressed, and then sintered may be used. Meanwhile, when a sintering start temperature is lowered due to atomization of nickel (Ni) particles of the conductive paste for internal electrodes, a sintering mismatch with a main component of the dielectric layer occurs, which may become more severe as the nickel (Ni) particles become more atomized.

As a method to alleviate such a sintering mismatch between the internal electrode and dielectric layer, there is provided a method of adding a large amount of common materials, organic materials, and dispersants, to the conductive paste for internal electrodes. However, the large amount of common materials, organic materials, and dispersants may cause a decrease in connectivity of the internal electrodes or an increase in a thickness of the dielectric layer.

Therefore, there is a need to develop an internal electrode having a higher sintering temperature than the existing nickel (Ni) internal electrode without adding a large amount of common materials, organic materials, and dispersants.

### SUMMARY

An aspect of the present disclosure is to provide a multilayer electronic component including an internal electrode having a high sintering temperature while having sufficient electrical conductivity, as compared to an Ni internal electrode.

An aspect of the present disclosure is to improve side effects that may occur due to interaction between an internal electrode and a dielectric layer, when an internal electrode of a multilayer electronic component formed of a material having a higher sintering temperature, as compared to an Ni internal electrode.

However, the problem to be solved by the present disclosure is not limited to the above-described contents, and will be more easily understood in the process of explaining specific embodiments of the present disclosure.

According to an aspect of the present disclosure, a multilayer electronic component includes a body including a dielectric layer and an internal electrode alternately disposed with the dielectric layer; and an external electrode disposed on the body, wherein the internal electrode includes at least one selected from the group consisting of a MAX material, a compound represented by the following [chemical formula 1] and a Silicide material, a compound represented by the following [chemical formula 2], wherein an auxiliary layer may be disposed at an interface between the internal electrode and the dielectric layer.

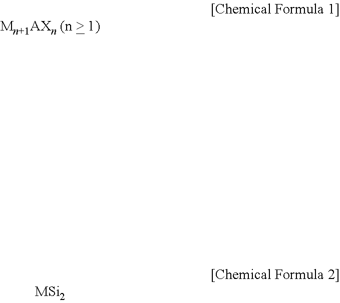

In chemical formulas 1 and 2 above, M is at least one selected from the group consisting of transition metal elements, A is at least one selected from the group consisting of aluminum (Al), silicon (Si), phosphorus (P), sulfur (S), copper (Cu), zinc (Zn), gallium (Ga), germanium (Ge), arsenic (As), cadmium (Cd), indium (In), tin (Sn), iridium (Ir), gold (Au), titanium (Ti), lead (Pb), and bismuth (Bi), and X is at least one selected from the group consisting of boron (B), carbon (C), and nitrogen (N).

### BRIEF DESCRIPTION OF DRAWINGS

The above and other aspects, features, and advantages of the present disclosure will be more clearly understood from the following detailed description, taken in combination with the accompanying drawings, in which:

FIG. 1 is a perspective view schematically illustrating a multilayer electronic component according to an embodiment of the present disclosure;

FIG. 2 is a cross-sectional view of FIG. 1, taken along line I-I′;

FIG. 3 is a cross-sectional view of FIG. 1, taken along line II-II′;

FIG. 4 is an enlarged view of region A of FIG. 3; and

FIG. 5 is an exploded perspective view illustrating components of a body according to an embodiment.

### DETAILED DESCRIPTION

Hereinafter, some embodiments of the present disclosure will be described as follows with reference to the attached drawings. The present disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art. Accordingly, shapes and sizes of elements in the drawings may be exaggerated for clear description, and elements indicated by the same reference numeral are the same elements in the drawings.

In the drawings, irrelevant descriptions will be omitted to clearly describe the present disclosure, and to clearly express a plurality of layers and areas, thicknesses may be magnified. The same elements having the same function within the scope of the same concept will be described with use of the same reference numerals. Throughout the specification, when a component is referred to as “comprise” or “comprising,” it means that it may further include other components as well, rather than excluding other components, unless specifically stated otherwise.

In the drawings, a first direction may be defined as a direction in which the first and second internal electrodes are alternately disposed with the dielectric layer interposed therebetween or a thickness (T) direction, and among second and third directions, perpendicular to the first direction, the second direction may be defined as a length (L) direction, and the third direction may be defined as a width (W) direction.

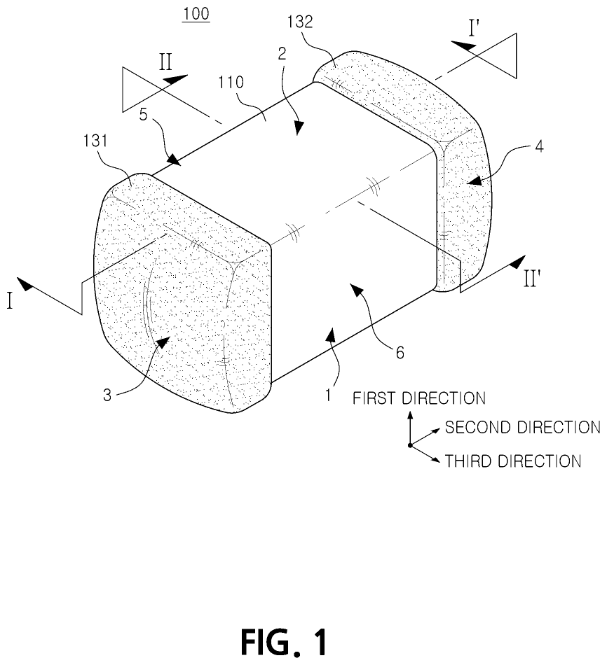

FIG. 1 is a perspective view schematically illustrating a multilayer electronic component according to an embodiment of the present disclosure.

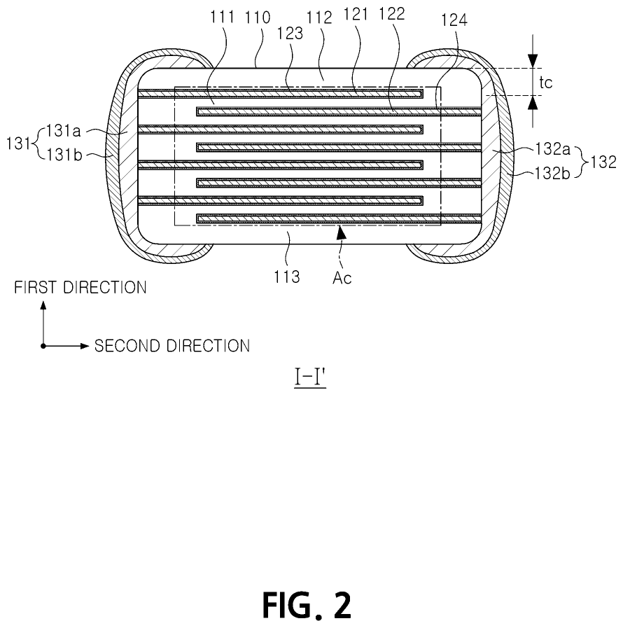

FIG. 2 is a cross-sectional view of FIG. 1, taken along line I-I′.

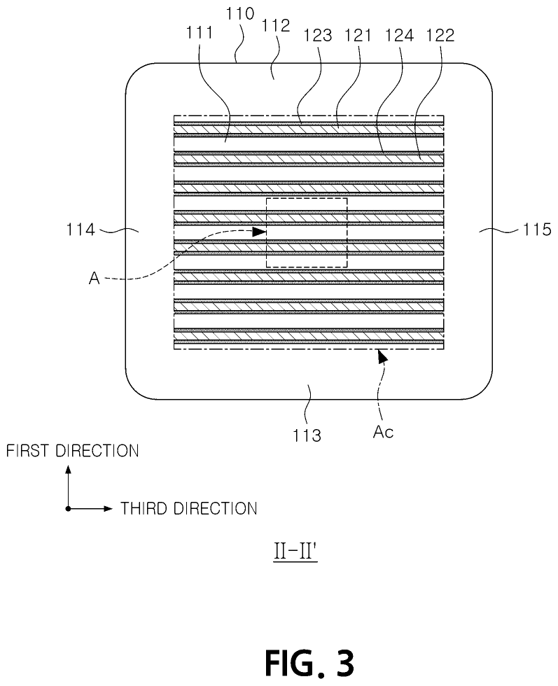

FIG. 3 is a cross-sectional view of FIG. 1, taken along line II-II′.

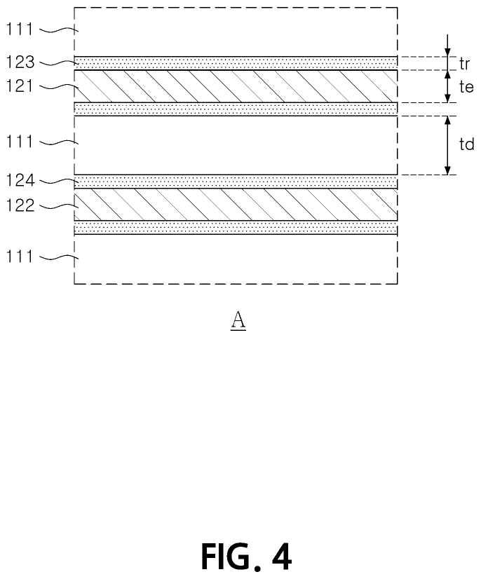

FIG. 4 is an enlarged view of region A of FIG. 3.

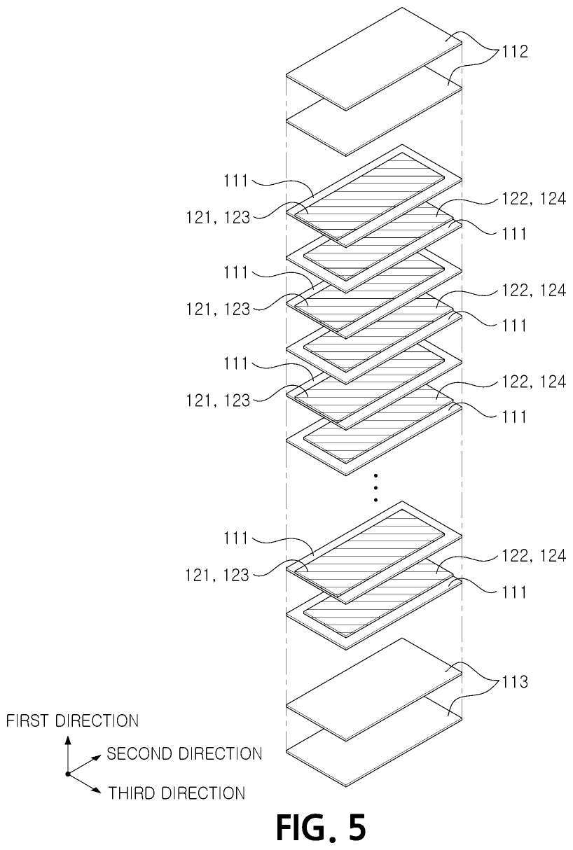

FIG. 5 is an exploded perspective view illustrating components of a body according to an embodiment.

A multilayer electronic component 100 according to an embodiment of the present disclosure may include a body 110 including a dielectric layer 111 and internal electrodes 121 and 122 alternately disposed with the dielectric layer; and external electrodes 131 and 132 disposed on the body, wherein the internal electrode may include at least one selected from the group consisting of a MAX material, a compound represented by [chemical formula 1], and a Silicide material, a compound represented by [chemical formula 2], and auxiliary layers 123 and 124 may be disposed at an interface between the internal electrode and the dielectric layer.

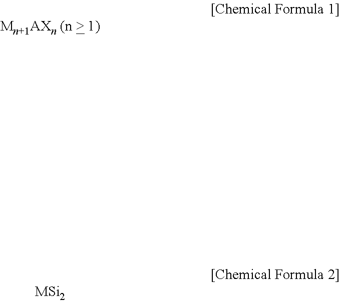

In chemical formulas 1 and 2 above, M is at least one selected from the group consisting of transition metal elements, A is at least one selected from the group consisting of aluminum (Al), silicon (Si), phosphorus (P), sulfur (S), copper (Cu), zinc (Zn), gallium (Ga), germanium (Ge), arsenic (As), cadmium (Cd), indium (In), tin (Sn), iridium (Ir), gold (Au), titanium (Ti), lead (Pb), and bismuth (Bi), and X is at least one selected from the group consisting of boron (B), carbon (C), and nitrogen (N).

The body 110 may have a dielectric layer 111 and internal electrodes 121 and 122 alternately disposed. Specifically, the first and second internal electrodes 121 and 122 may be disposed alternately with the dielectric layer 111 interposed therebetween.

The body 110 is not limited to a particular shape, and may have a hexahedral shape or a shape similar to the hexahedral shape, as illustrated in the drawings. The body 110 may not have a hexahedral shape having perfectly straight lines because ceramic powder particles included in the body 110 may be contracted in a process in which the body is sintered. However, the body 110 may have a substantially hexahedral shape.

The body 110 may have first and second surfaces 1 and 2 opposing each other in a first direction, third and fourth surfaces 3 and 4 connected to the first and second surfaces 1 and 2 and opposing each other in a second direction, and fifth and sixth surfaces 5 and 6 connected to the first and second surfaces 1 and 2 and connected to the third and fourth surfaces 3 and 4 and opposing each other in a third direction. In this case, the first direction may be defined as a direction in which the dielectric layer 111 and the internal electrodes 121 and 122 are alternately disposed.

A plurality of dielectric layers 111 for forming the body 110 may be in a sintered state, and adjacent dielectric layers 111 may be integrated with each other, such that boundaries therebetween may not be readily apparent without using a scanning electron microscope (SEM).

According to an embodiment of the present disclosure, a raw material for forming the dielectric layer 111 is not particularly limited, as long as sufficient electrostatic capacitance may be obtained therewith. For example, the raw material for forming the dielectric layer 111 may be a barium titanate (BaTiO₃)-based material, a lead composite perovskite-based material, a strontium titanate (SrTiO₃)-based material, or the like. The barium titanate-based material may include BaTiO₃-based ceramic powder, and the ceramic powder may be, for example, BaTiO₃, (Ba₁₋ₓCaₓ)TiO₃ (0<x<1), Ba(Ti_{1-y}Ca_{y})O₃ (0<y<1), (Ba₁₋ₓCaₓ)(Ti_{1-y}Zr_{y})O₃ (0<x<1, 0<y<1) or Ba(Ti_{1-y}Zr_{y})O₃ (0<y<1), in which calcium (Ca), zirconium (Zr), or the like, are partially dissolved in BaTiO₃, and the like. That is, the dielectric layer 111 may include at least one of barium (Ba) and titanium (Ti).

Meanwhile, an average thickness of the dielectric layer 111 is not particularly limited. For example, the average thickness of the dielectric layer 111 may be 0.2 μm or more and 2 μm or less.

The average thickness of the dielectric layer 111 may mean an average thickness of the dielectric layer 111 disposed between the first and second internal electrodes 121 and 122.

The average thickness of the dielectric layer 111 may be measured by scanning an image of a cross-section of the body 110 in the length and thickness directions (L-T directions) with a scanning electron microscope (SEM) at a magnification of 10,000. More specifically, an average value may be measured by measuring a thickness of one dielectric layer at 30 equally spaced points in the length direction in the scanned image. The 30 equally spaced points may be designated in the capacitance formation portion Ac. In addition, if such an average value is measured by extending the average value measurement to 10 dielectric layers, the average thickness of the dielectric layers may be further generalized.

The body 110 may include a capacitance formation portion Ac in which the first and second internal electrodes 121 and 122 overlap in the first direction and cover portions 112 and 113 formed above and below the capacitance formation portion Ac in the first direction.

In addition, the capacitance formation portion Ac is a portion serving to contribute to capacitance formation of a capacitor, and may be formed by repeatedly stacking a plurality of first and second internal electrodes 121 and 122 with a dielectric layer 111 interposed therebetween.

The cover portions 112 and 113 may include an upper cover portion 112 disposed on one surface of the capacitance formation portion Ac in the first direction, and a lower cover portion 113 disposed on the other surface of the capacitance formation portion Ac in the first direction.

The cover portions 112 and 113 may be formed by stacking a single dielectric layer or two or more dielectric layers on the upper and lower surfaces of the capacitance formation portion Ac in a thickness direction, respectively, and may serve to basically prevent damage to the internal electrodes due to physical or chemical stress.

The cover portions 112 and 113 may not include an internal electrode, and may include the same material as that of the dielectric layer 111.

That is, the cover portions 112 and 113 may include a ceramic material, for example, a barium titanate (BaTiO₃)-based ceramic material.

Meanwhile, an average thickness of the cover portions 112 and 113 is not particularly limited. However, an average thickness “tc” of the cover portions 112 and 113 may be 15 μm or less in order to more easily achieve miniaturization and high capacitance of the multilayer electronic component. The average thickness of the cover portions 112 and 113 may mean a size thereof in the first direction, and may be a value obtained by averaging sizes of the cover portions 112 and 113 in the first direction measured at 5 equally spaced points above or below the capacitance formation portion Ac.

Margin portions 114 and 115 may be disposed on a side surface of the capacitance formation portion Ac.

The margin portions 114 and 115 may include a margin portion 114 disposed on the fifth surface 5 of the body 110 and a margin portion 115 disposed on the sixth surface 6 of the body 110. That is, the margin portions 114 and 115 may be disposed on both end surfaces of the body in a third direction (width direction).

The margin portions 114 and 115 may mean a region between both ends of the first and second internal electrodes 121 and 122 and a boundary surface of the body 110 in a cross-section of the body 110, cut in a width-thickness (W-T) direction, as illustrated in FIG. 3.

The margin portions 114 and 115 may basically serve to prevent damage to the internal electrodes due to physical or chemical stress.

The margin portions 114 and 115 may be formed by applying a conductive paste to the ceramic green sheet, except where margin portions are to be formed, to form an internal electrode.

In addition, in order to suppress a step by the internal electrodes 121 and 122, after the internal electrodes are cut so as to be exposed to the fifth and sixth surfaces 5 and 6 of the body after lamination, the margin portions 114 and 115 may also be formed by stacking a single dielectric layer or two or more dielectric layers on both side surfaces of the capacitance formation portion Ac in the third direction (width direction).

Meanwhile, a width of the margin portions 114 and 115 is not particularly limited. However, in order to more easily implement miniaturization and high capacitance of the multilayer electronic component, an average width of the margin portions 114 and 115 may be 15 μm or less. The average width of the margin portions 114 and 115 may mean an average size of the margin portions 114 and 115 in the third direction, and may be a value obtained by averaging sizes of the margin portions 114 and 115 measured at 5 equally spaced points in the third direction in terms of the capacitance formation portion Ac.

The internal electrodes 121 and 122 may be disposed alternately with the dielectric layer 111 in the first direction.

The internal electrodes 121 and 122 may include first and second internal electrodes 121 and 122. The first and second internal electrodes 121 and 122 may be alternately disposed to oppose each other with the dielectric layer 111 constituting the body 110, interposed therebetween, and may be connected to the third and fourth surfaces 3 and 4 of the body 110, respectively. Specifically, one end of the first internal electrode 121 may be connected to the third surface, and one end of the second internal electrode 122 may be connected to the fourth surface.

The first internal electrode 121 may be spaced apart from the fourth surface 4 and be exposed through the third surface 3, and the second internal electrode 122 may be spaced apart from the third surface 3 and be exposed through the fourth surface 4. A first external electrode 130 may be disposed on the third surface 3 of the body and be connected to the first internal electrode 121, and a second external electrode 140 may be disposed on the fourth surface 4 of the body and be connected to the second internal electrode 122.

That is, the first internal electrode 121 is not connected to the second external electrode 140 but is connected to the first external electrode 130, and the second internal electrode 122 is not connected to the first external electrode 130 but is connected to the second external electrode 140. Accordingly, the first internal electrode 121 may be formed to be spaced apart from the fourth surface 4 by a predetermined distance, and the second internal electrode 122 may be formed to be spaced apart from the third surface 3 by a predetermined distance.

In this case, the first and second internal electrodes 121 and 122 may be electrically isolated from each other by the dielectric layer 111 disposed in a middle.

The body 110 may be formed by alternately stacking a ceramic green sheet on which the first internal electrode 121 is printed and a ceramic green sheet on which the second internal electrode 122 is printed, followed by sintering.

An average thickness of the internal electrodes 121 and 122 is not particularly limited. For example, the average thickness of the internal electrodes 121 and 122 may be 0.2 μm or more and 2 μm or less.

The average thickness of the internal electrodes 121 and 122 may be an average thickness of the internal electrodes 121 and 122.

The average thickness of the internal electrodes 121 and 122 may be measured by scanning an image of a cross-section of the body 110 in the length and thickness directions (L-T directions) with a scanning electron microscope (SEM) at a magnification of 10,000. More specifically, an average value of one internal electrode may be measured by measuring a thickness of one internal electrode at 30 equally spaced points in the length direction in the scanned image. The 30 equally spaced points may be designated in the capacitance formation portion Ac. In addition, if the average value is measured by extending the average value measurement to 10 internal electrodes, the average thickness of the internal electrodes can be further generalized.

External electrodes 131 and 132 may be disposed on the third surface 3 and the fourth surface 4 of the body 110. The external electrodes 131 and 132 may include a first external electrode 131 disposed on the third surface 3 of the body 110 and connected to the first internal electrode 121 and a second external electrode 132 disposed on the fourth surface 4 of the body 110 and connected to the second internal electrode 122.

In the present embodiment, a structure in which the multilayer electronic component 100 has two external electrodes 131 and 132 is described. However, the number and shape of the external electrodes 131 and 132 may be changed according to the shape of the internal electrodes 121 and 122 or any other purposes.

Meanwhile, the external electrodes 131 and 132 may be formed using any material as long as it has electrical conductivity, such as metal, and a specific material may be determined in consideration of electrical characteristics, structural stability, or the like, and further, may have a multilayer structure.

For example, the external electrodes 131 and 132 may include electrode layers 131a and 132a disposed on the body 110 and plating layers 131b and 132b formed on the electrode layer.

For a more specific example of the electrode layers 131a and 132a, the electrode layers 131a and 132a may be sintered electrodes including a conductive metal and glass, or resin-based electrodes including a conductive metal and resin.

In addition, the electrode layers 131a and 132a may have a form in which a sintered electrode and a resin-based electrode are sequentially formed on the body 110. In addition, the electrode layers 131a and 132a may be formed by transferring a sheet including a conductive metal onto a body or by transferring a sheet including a conductive metal onto a sintered electrode.

A material having excellent electrical conductivity may be used as a conductive metal included in the electrode layers 131a and 132a, and is not particularly limited. For example, the conductive metal may be at least one selected from the group consisting of nickel (Ni), copper (Cu), and alloys thereof.

The plating layers 131b and 132b may serve to improve mounting characteristics. A type of the plating layers 131b and 132b is not particularly, and may be a plating layer including at least one selected from the group consisting of Ni, Sn, Pd, and alloys thereof, and may be formed of a plurality of layers.

For a more specific example of the plating layers 131b and 132b, the plating layers 131b and 132b may be an Ni plating layer or an Sn plating layer, may have a form in which an Ni plating layer and an Sn plating layer are sequentially formed on the electrode layers 131a and 132a, and have a form in which an Sn plating layer, an Ni plating layer, and an Sn plating layer are sequentially formed. In addition, the plating layers 131b and 132b may also include a plurality of Ni plating layers and/or a plurality of Sn plating layers.

A conventional internal electrode having an Ni single composition may have a problem in that connectivity of the internal electrode deteriorates due to a sintering mismatch caused by a difference in a sintering temperature with a barium titanate (BaTiO₃)-based material of the dielectric layer. In addition, if a large amount of common materials is added to the internal electrode to alleviate the sintering mismatch between the internal electrode having such an Ni single composition and the dielectric layer, a problem of increasing a thickness of the dielectric layer may occur.

Accordingly, in some embodiments of the present disclosure, the internal electrodes 121 and 122 may include at least one selected from the group consisting of a MAX material and a Silicide material, so that the sintering mismatch between the internal electrodes 121 and 122 and the dielectric layer 111 may be improved. In addition, because of improving the sintering mismatch between the internal electrodes 121 and 122 and the dielectric layer 111, when the internal electrodes 121 and 122 are formed, there may be no need to add an excessive amount of common materials, and thus the problem of increasing the thickness of the dielectric layer 111 may also be alleviated.

In some embodiments, the MAX material is a precursor of MXene, a two-dimensional inorganic compound, and may mean a ceramic material having crystallinity and a hexagonal layered structure. Such a Max material is a ceramic material, but has electrical conductivity similar to that of metal (>10⁶ S/m), and have a sintering temperature, which is approximately 100° C. to 300° C. or higher than the sintering temperature of Ni. Accordingly, when the internal electrodes 121 and 122 include a MAX material as in some embodiments of the present disclosure, the side effects due to the sintering mismatch between the internal electrode and barium titanate (BaTiO₃) of the dielectric layer may be alleviated.

The MAX material may be expressed by the following [Chemical Formula 1].

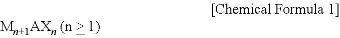

M is at least one selected from the group consisting of transition metal elements, A is at least one selected from the group consisting of aluminum (Al), silicon (Si), phosphorus (P), sulfur (S), copper (Cu), zinc (Zn), gallium (Ga), germanium (Ge), arsenic (As), cadmium (Cd), indium (In), tin (Sn), iridium (Ir), gold (Au), titanium (Ti), lead (Pb), and bismuth (Bi), and X is at least one selected from the group consisting of boron (B), carbon (C), and nitrogen (N).

In some embodiments, the Silicide material may be represented by the following [Chemical Formula 2], and may be a material having high electrical conductivity of 10⁶ S/m, similar to that of the MAX material, and having a sintering temperature, which is several times higher than that of Ni. The Silicide material may have various crystal systems depending on the type of element combining with silicon (Si). Therefore, when the internal electrodes 121 and 122 include a Silicide material as in some embodiments of the present disclosure, the side effect due to the sintering mismatch between the internal electrode and barium titanate (BaTiO₃) of the dielectric layer may be alleviated.

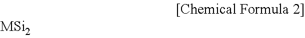

M is at least one element selected from the group consisting of transition metal elements.

Meanwhile, as in some embodiments, when the internal electrodes 121 and 122 include at least one selected from the group consisting of a MAX material and a Silicide material, a portion of the ceramic MAX material and the Silicide material may diffuse into a dielectric layer 111, thereby changing the composition of the dielectric layer 111, or forming a secondary phase in the dielectric layer 111, which may cause a problem in that permittivity of the multilayer electronic component 100 may be reduced or reliability thereof may be reduced.

Accordingly, in a multilayer electronic component 100 according to some embodiments of the present disclosure, auxiliary layers 123 and 124 mat be disposed at an interface between the internal electrodes 121 and 122 and the dielectric layer 111, the problem of reduced permittivity or reduced reliability due to the interaction between the internal electrodes 121 and 122 and the dielectric layer 111 may be improved, and by forming contact resistance at the interface between the internal electrodes 121 and 122 and the dielectric layer 111, insulating properties of the dielectric layer 111 may also be improved.

In some embodiments, a material included in the auxiliary layers 123 and 124 may be a two dimensional (2D) material or an ultra-thin material of 5 nm or less. Examples of 2D or ultra-thin materials may include at least one selected from the group consisting of MXene, Graphene, Hf₁₋ₓZrₓO₂ (0<x<1), MoTe₂, MoSe₂, transition metal chalcogenide, a 2-dimensional (2D) perovskite material, and Hexagonal Boron Nitride (h-BN). Such a 2D or ultra-thin film material may improve the problem of reduced permittivity or reduced reliability due to the change in the composition of the dielectric or the generation of a secondary phase by preventing the interaction such as material movement between the internal electrodes 121 and 122 and the dielectric layer 111.

In particular, when the auxiliary layers 123 and 124 include HfO₂, ZrO₂, Hf₁₋ₓZrₓO₂ (0<x<1) and 2-dimensional (2D) perovskite as high-κ materials having a dielectric constant of 4 or more, the 2D and ultra-thin film materials have a high band gap energy of 3.0 eV or more, so that they can generate sufficient contact resistance at the interface between the internal electrodes 121 and 122 and the dielectric layer 111, thereby improving insulating properties of the dielectric layer 111.

Meanwhile, if electrical conductivity of the auxiliary layers 123 and 124 is excessively low, the energy storage density and efficiency may be reduced, and thus it may be difficult to improve the dielectric properties of the dielectric layer 111. Therefore, in the auxiliary layers 123 and 124, using a material having electrical conductivity at the level of a semiconductor material, for example, using a material having an electrical conductivity of 10⁻⁶ to 10² S/m, may be effective in improving the insulating properties of the dielectric layer 111. Specifically, in some embodiments, the auxiliary layers 123 and 124 may include at least one selected from the group consisting of Hf₁₋ₓZrₓO₂ (0<x<1), transition metal chalcogenide, and a 2-dimensional (2D) perovskite material, and may secure appropriate energy storage density and efficiency.

In some embodiments, the sintering process of the multilayer electronic component 100 may be performed through a rapid temperature increase process.

Meanwhile, when the auxiliary layers 123 and 124 include a 2D perovskite material or metal oxide, there is a possibility that it will react with an oxide of the dielectric layer 111 during sintering. However, since the sintering process of the multilayer electronic component 100 according to some embodiments may be performed through a rapid temperature-increase process, sintering may be completed before an oxide of the auxiliary layers 123 and 124 and an oxide of the dielectric layer 111 react.

Meanwhile, when the auxiliary layers 123 and 124 include at least one selected from the group consisting of transition metal chalcogenide, graphene, and hexagonal boron nitride (h-BN), the material included in the auxiliary layers 123 and 124 may be oxidized and react with the internal electrodes 121 and 122 or the dielectric layer 111 when a sintering atmosphere is under high pressure, and the material included in the auxiliary layers 123 and 124 may partially diffuse into the internal electrodes 121 and 122 or the dielectric layer 111 when the sintering atmosphere is under low pressure. However, since a temperature-increase process of the multilayer electronic component 100 according to some embodiments may be performed through the rapid temperature-increase process, sintering may be completed before the material included in the auxiliary layers 123 and 124 is oxidized or diffused.

Specific conditions of the rapid temperature-increase process according to some embodiments may be faster than a general sintering temperature-increase rate of 10° C./min, and may be, for example, a temperature-increase condition of 100° C./min to 1000° C./min.

Meanwhile, a method for measuring whether a MAX material, a compound represented by [chemical formula 1] according to some embodiments of the present disclosure, and a Silicide material, a compound represented by [chemical formula 2], are present in the internal electrodes 121 and 122 is not particularly limited.

As an example, there is a method of matching a peak observed by analyzing a cross-section of the multilayer electronic component 100 in the first and third directions, polished to a central portion of the multilayer electronic component 100 in the second direction, with a peak of a MAX material or a Silicide material, or a method of obtaining composition information by analyzing a cross-section of the multilayer electronic component 100 in the first and third directions, polished to the central portion of the multilayer electronic component 100 in the second direction through Scanning Electron Microscope Energy Dispersive X-ray Spectroscopy (SEM-EDS), and matching the same with the composition information of the MAX material or the Silicide material, but some embodiments thereof is not limited thereto.

In some embodiments, the auxiliary layers 123 and 124 may cover at least a portion of surfaces of the internal electrodes 121 and 122. Accordingly, interaction due to direct contact between the internal electrodes 121 and 122 and the dielectric layer 111 may be suppressed.

Meanwhile, it may be preferable for the auxiliary layers 123 and 124 to cover all surfaces of the internal electrodes 121 and 122 except for the surface of the internal electrodes 121 and 122 connected to the external electrodes 131 and 132. Accordingly, as shown in FIG. 4, the dielectric layer 111 and the internal electrodes 121 and 122 may have a structure separated by the auxiliary layers 123 and 124 interposed therebetween.

Referring to FIG. 4, an average thickness of the internal electrode may be represented as te, and an average thickness of the auxiliary layers 123 and 124 may be represented as tr.

In some embodiments, tr/te may be 0.00025 or more and 0.05 or less.

When tr/te is less than 0.00025, an effect of improving insulating properties, preventing a decrease in permittivity, and preventing interaction between the dielectric layer 111 and the internal electrodes 121 and 122 according to the present disclosure may be insufficient. When tr/te exceeds 0.05, resistance of the multilayer electronic component may increase, and permittivity may decrease significantly, making it difficult to secure sufficient capacitance per unit volume of the multilayer electronic component.

Accordingly, in some embodiments, by satisfying tr/te of 0.00025 or more and 0.05 or less, the effects of improving insulating properties, preventing a decrease in permittivity, and preventing interaction between the dielectric layer 111 and the internal electrodes 121 and 122 may be sufficiently obtained, and the problem of increased resistance of the multilayer electronic component or a significant decrease in capacitance per unit volume can be alleviated.

Meanwhile, an average thickness “tr” of the auxiliary layers 123 and 124 may be determined in relation to the average thickness “te” of the internal electrodes 121 and 122, but some embodiments thereof is not limited thereto, and may be 0.5 nm or more and 5 nm or less.

In some embodiments, the dielectric layer 111 may further include at least one of rare earth elements, and the rare earth elements may act as a barrier to block a flow of electrons at grain boundaries, thereby suppressing an increase in leakage current.

In some embodiments, the dielectric layer 111 may further include at least one element selected from the group consisting of elements that substitute for an A-site of an ABO₃ structure of barium titanate to act as a donor and elements that substitute for a B-site to act as an acceptor.

A donor element that can be substituted in the A-site may form electrons to improve permittivity, and an acceptor element that can be substituted in the B-site may form oxygen vacancies to reduce dielectric loss and bind electrons to improve insulating properties.

Meanwhile, when a pentavalent donor element and divalent and trivalent acceptor elements are added to BaTiO₃ and sintering is performed under appropriate conditions, a dielectric layer 111 having a higher permittivity (over 7000) compared to the conventional general permittivity (about 2000 to 4000) may be formed. That is, in some embodiments, the dielectric layer 111 may include at least one of a divalent acceptor element or a trivalent acceptor element, and may include a pentavalent donor element, thereby improving the permittivity of the dielectric layer 111.

At least one element selected from the group consisting of aluminum (Al), gallium (Ga), magnesium (Mg), zinc (Zn), scandium (Sc), indium (In), ytterbium (Yb), thallium (Ti), erbium (Er), and europium (Eu) is an element that can be dissolved in an appropriate concentration in the B-site considering an ionic radius of Ti tetravalent element (74.5 pm) or an ionic radius of Ti trivalent element (81 pm). Therefore, in some embodiments, the dielectric layer 111 may include at least one element selected from the group consisting of aluminum (Al), gallium (Ga), magnesium (Mg), zinc (Zn), scandium (Sc), indium (In), ytterbium (Yb), thallium (Tl), erbium (Er), and europium (Eu), and accordingly, the effect of improving the permittivity of the dielectric layer 111 may become more significant.

Meanwhile, examples of pentavalent donor elements which are effective in improving the permittivity of the dielectric layer 111 may include niobium (Nb) and tantalum (Ta). That is, in some embodiments, the dielectric layer 111 may further include at least one of niobium (Nb) or tantalum (Ta).

Meanwhile, when the dielectric layer 111 includes at least one of a divalent acceptor element or a trivalent acceptor element, and at least one pentavalent donor element to implement high permittivity of 7000 or more, the effect of reducing insulation resistance may occur due to a Defect-Cluster structure excessively formed in the dielectric layer. Accordingly, the BDV characteristics of the multilayer electronic component may be lowered, resulting in the capacitor element not being able to fully function. However, according to some embodiments of the present disclosure, the internal electrodes 121 and 122 include at least one selected from the group consisting of a MAX material, a compound represented by [chemical formula 1], and a Silicide material, a compound represented by [chemical formula 2], and auxiliary layers 123 and 124 are disposed at an interface between the internal electrodes 121 and 122 and the dielectric layer 111. Since the problem of reduced permittivity or reduced reliability due to interaction between the internal electrodes 121 and 122 and the dielectric layer 111 may be improved, and the insulating properties of the dielectric layer 111 may also be improved by forming contact resistance at the interface between the internal electrodes 121 and 122 and the dielectric layer 111, the above-described side effects due to the high permittivity may be suppressed.

A method for manufacturing a multilayer electronic component 100 according to some embodiments of the present disclosure is not particularly limited. For example, according to the purpose of the present disclosure, a dielectric sheet may be formed by adding various ceramic additives, organic solvents, binders, dispersants, or the like, to power such as barium titanate (BaTiO₃), an auxiliary layer may be formed on the dielectric sheet by depositing, transferring, printing, or the like, a 2D high permittivity material, a conductive paste for internal electrodes including at least one material selected from the group consisting of a MAX material and a Silicide material may be formed on the dielectric sheet by a screen printing method, a gravure printing method, or the like, and then an auxiliary layer may be formed again on the printed conductive paste to form a laminate.

The laminate thus formed may be subjected to a pre-sintering process at a temperature within a range of 350° C. to 800° C. to remove organic materials, and then be subjected to a main sintering process at a temperature within a range of 1000° C. to 1300° C. or a low-temperature sintering process at a temperature within a range of 350° C. to 800° C. under a H₂/H₂O/N₂ atmosphere. After the laminate having performed the sintering process in this manner, a termination process and electrode sintering may be performed with a paste for an external electrode to complete the multilayer electronic component 100.

As set forth above, according to one of the various effects of the present disclosure, an internal electrode includes at least one selected from the group consisting of a MAX material and a Silicide material, so that a sintering mismatch between an internal electrode and a dielectric layer is alleviated.

According to one of the various effects of the present disclosure, by forming an auxiliary layer at an interface between an internal electrode and a dielectric layer, when the internal electrode includes at least one selected from the group consisting of a MAX material and a Silicide material, side effects that may occur when the internal electrode interacts with the dielectric layer are improved.

Although the embodiments of the present disclosure have been described in detail above, the present disclosure is not limited by the above-described embodiments and the accompanying drawings, and is intended to be limited by the appended claims. Therefore, various forms of substitution, modification, and change will be possible by those skilled in the art within the scope of the technical spirit of the present disclosure described in the claims, which also falls within the scope of the present disclosure.

In addition, the expression ‘one embodiment’ used in the present disclosure does not mean the same embodiment, and is provided to emphasize and describe different unique characteristics. However, one embodiment presented above is not excluded from being implemented in combination with features of another embodiment. For example, even if a matter described in one specific embodiment is not described in another embodiment, it can be understood as a description related to another embodiment, unless there is a description contradicting or contradicting the matter in the other embodiment.

Terms used in this disclosure are only used to describe one embodiment, and are not intended to limit the disclosure. In this case, singular expressions include plural expressions unless the context clearly indicates otherwise.

While the example embodiments have been illustrated and described above, it will be configured as apparent to those skilled in the art that modifications and variations could be made without departing from the scope of the present disclosure as defined by the appended claims.

What is claimed is:

1. A multilayer electronic component, comprising:
a body including a dielectric layer and an internal electrode alternately disposed with the dielectric layer; and
an external electrode disposed on the body,
wherein the internal electrode includes at least one selected from the group consisting of a MAX material, a compound represented by the following chemical formula 1 and a Silicide material, a compound represented by the following chemical formula 2,
wherein an auxiliary layer is disposed at an interface between the internal electrode and the dielectric layer, 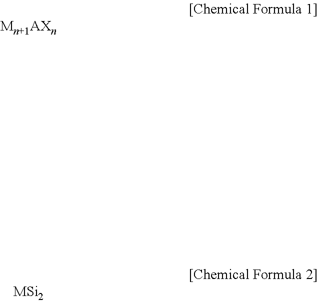
in chemical formulas 1 and 2,
M is at least one selected from the group consisting of transition metal elements,
A is at least one selected from the group consisting of aluminum (Al), silicon (Si), phosphorus (P), sulfur (S), copper (Cu), zinc (Zn), gallium (Ga), germanium (Ge), arsenic (As), cadmium (Cd), indium (In), tin (Sn), iridium (Ir), gold (Au), titanium (Ti), lead (Pb), and bismuth (Bi),
X is at least one selected from the group consisting of boron (B), carbon (C), and nitrogen (N), and
n is an rational number of 1 or more.

2. The multilayer electronic component of claim 1, wherein the auxiliary layer covers at least a portion of a surface of the internal electrode.

3. The multilayer electronic component of claim 1, wherein the dielectric layer and the internal electrode are separated with the auxiliary layer interposed therebetween.

4. The multilayer electronic component of claim 1, wherein, when an average thickness of the internal electrode is te, and an average thickness of the auxiliary layer is tr, tr/te is 0.00025 or more and 0.05 or less.

5. The multilayer electronic component of claim 1, wherein, when an average thickness of the auxiliary layer is tr, tr is 0.5 nm or more and 5 nm or less.

6. The multilayer electronic component of claim 1, wherein the auxiliary layer comprises at least one selected from the group consisting of MXene, Graphene, HfO₂, ZrO₂, Hf₁₋ₓZrₓO₂ (0<x<1), MoTe₂, MoSe₂, transition metal chalcogenide, a 2-dimensional (2D) perovskite material, and hexagonal boron nitride (h-BN).

7. The multilayer electronic component of claim 1, wherein the auxiliary layer comprises at least one selected from the group consisting of Hf₁₋ₓZrₓO₂ (0<x<1), transition metal chalcogenide, and a 2-dimensional (2D) perovskite material.

8. The multilayer electronic component of claim 1, wherein the dielectric layer comprises at least one of Ba or Ti.

9. The multilayer electronic component of claim 8, wherein the dielectric layer further comprises at least one of rare earth elements.

10. The multilayer electronic component of claim 8, wherein the dielectric layer further comprises at least one selected from the group consisting of aluminum (Al), gallium (Ga), magnesium (Mg), zinc (Zn), scandium (Sc), indium (In), ytterbium (Yb), thallium (Tl), erbium (Er), and europium (Eu).

11. The multilayer electronic component of claim 8, wherein the dielectric layer further comprises at least one of niobium (Nb) or tantalum (Ta).
